(19) United States
(12) Patent Application Publication
(10) Pub. No.: US 2003/0174851 A1
(43) Pub. Date: Sep. 18, 2003

(54) SYSTEM AND METHOD TO IMPROVE THE LOW FREQUENCY PERFORMANCE OF ELECTRO ACOUSTIC TRANSDUCERS

(76) Inventor: Jan Princeton Plummer, Marietta, GA (US)

Correspondence Address: JAN P. PLUMMER, 341 ENGLAND PL NE., MARIETTA, GA, 30066, US

(21) Appl. No.: 10/250,078

(22) Filed: Jun. 2, 2003

Related U.S. Application Data
(63) Continuation-in-part of application No. 09/443,343, filed on Nov. 19, 1999, now abandoned.

(51) Int. Cl. H04R 1/02; H04R 1/20

(52) U.S. Cl. 381/339; 381/345; 381/350

(57) ABSTRACT

A hybrid bass reflex loudspeaker system capable of optimized sub-bass (<250 Hz) response. The basic low frequency loudspeaker system incorporates a ported cabinet, an electromechanical driver, a virtual acoustic radial transmission line (VARTL) and a radial right angle wave-guide (RRAWG). The aperiodic VARTL is disposed around and in front of the cone of the driver so as to allow the driver to maintain loading to very low frequencies, while simultaneously isolating the driver from reflected signals acoustic summation or stimulus. The VARTL slows the speed of the wave, thereby causing delay and intentional loading of the driver cone while, by the way of radial expansion, allows adequate exit velocity VARTL enhanced loading increases the effective isolation of driver and port to enhance the depth of the cone null at resonance to approach infinity. The RRAWG acts as a guide and is disposed within the VARTL to introduce the wave into the throat of the VARTL, thereby allowing the cone to drive the box air mass and the VARTL air mass with essentially equal pressure on each cycle throughout the frequency range of the VARTL. The driver resonates the port without differential air load on the cone effectively synthesizing isobaric operation and an increased Vas for the driver. In addition, the loudspeaker system effectively reduces mechanical vibrations that are normally transferred to the speaker cabinet by affecting a lack of unbalanced pressures.

### BACKGROUND OF INVENTION

Although much has changed in the field of audio since its' inception, little has changed in the development of loudspeakers. The reproduction of the higher range of frequencies has always been straightforward however the reproduction of very low frequencies has remained the Achilles heel of the industry. There are probably more configurations for patents to produce bass than any other single speaker patent. Most are reconfigurations that sacrifice one quality for another. The real problems start with the room where the low frequencies are being produced. The laws of acoustics have always prevented the designers efforts from being replicated repeatedly in the field. Most designers assume free field or no room conditions for neutrality when the room must come into the final equation. Current subwoofer designs are faced with the unknown room factor even if the technologies employed were capable of solving the various issues associated with launching long wavelength signals. High efficiency, low distortion and deep frequency response are important but the issues of timing and integration with other component speakers have eluded the industry. It is not important that deep high intensity bass is available if it does not sound natural when used in the field with unknown speaker products at normal levels.

Current art systems designed to reproduce bass frequencies generally must compromise in sound quality by the very nature of their design. Compromises in bass quality contribute most to the non-specific subjective aspects of sound systems evaluation. The current methods of reproducing sound all revolve around the same early principles virtually 100 years old. In the early 1950s' the Thiele-Small parameters [T/S] were developed to more accurately predict the sound of bass speakers modeled on the then known practical empirical approaches. These principles all evolve around large diameter drivers in large enclosures with only marginal success with more recent smaller subwoofer designs. The smaller designs require more mass and cone travel therefore they do not work as well as the larger ones. While there are many types of low frequency loudspeaker designs most are empirical adaptations of the T/S equations. This means that the T/S formulas predict a graph that requires empirical manipulation of values to achieve sonic objectives. Sometimes the designer will follow the design formulas only to alter the values to sound best in a particular product or environment. The goal of achieving an objective bass quality in different environments with different sound systems is an apparently insurmountable goal using present day design methods. In general it is accepted that the limitations mentioned in this application are facts governed by the laws of physics and any attempt to overcome one anomaly will result in compromise in another performance area.

The current approach requires drivers of high mass and low resonance frequency to improve efficiency and to produce low bass even though the product application does not require play at high levels. The drivers are operated at their resonant frequency to obtain bass output, level independent. This approach violates the physics employed to reproduce sound in the other frequency ranges where operation of the drivers in the resonant frequency range is forbidden. At resonance the signal cannot control the driver yet all current woofer-subwoofer designs require operation in this range. It is the goal of the pending invention to eliminate much of the compromise associated with current design methods including the need for large size woofers and cabinets.

### SUMMARY OF INVENTION

Specifically the present invention relates to improving the quality and consistency of bass sounds to include:

Â—Solving the timing issues associated with the fundamental and harmonic structures of sound waves being produced by two different bass frequency transducers operating in different ranges.

Â—Improving the quality of sound at lower listening levels.

Â—Reducing the vibration transmitted to the walls of the woofer enclosure and surroundings.

Â—Reducing the effect of room acoustics on the consistency of sound quality in the field.

Â—Reducing the physical size of enclosures normally associated with reproducing low frequencies.

Â—Providing these improvements at a much lower cost for construction.

The present invention teaches a method of improving the acoustic impedance matching for dynamic loudspeaker drivers operating at low frequencies. A better impedance match means less cone motion is required for a given sized driver to produce low frequency sounds. The laws of physics require a large driver if bass frequencies are to be produced in the same manner that the upper frequencies are generated as a direct radiator.

A piston generating sound without an enclosure begins to become ineffective when the wavelength of the sound being produced becomes equal to the drivers circumference. Even large drivers are ineffective at generating bass frequencies without assistance from some form of enclosure or wall to support the launch and to isolate the front and back waves of the cone.

The pending invention does not lend itself to a particular enclosure dimension or driver size and can be imbedded into host products as well as independent units that are complimentary to a variety of sound systems. In particular it relates to an acoustical-enclosure design method that allows low mass drivers of different diameters to be used in enclosures of modest dimensions relative to the driver size to produce low bass frequencies. Although efficiency isn't claimed as a benefit of the subject invention, the use of a 3″ driver in a 0.02 cubic foot box to produce deep bass frequencies at near its” mid-band level is highly efficient since there is no other means of accomplishing this. The acoustic impedance matching allows the subject driver to produce low bass frequencies at near its' mid-band efficiency while requiring less than mid-band cone excursion.

This matching of the acoustic impedance for lower bass frequencies will come at a slight reduction in sensitivity to upper bass frequencies so there are alternate means described within for increasing the sound level of the upper bass frequencies that have lost some sensitivity due to this process. There are still other embodiments of the system described herein that allow for improved quality and increased efficiency in a narrow bass range or over a wider bass range.

Another advantage of the present invention is the isolation of the driver-cone assembly from reflected waves that exist in a typical room. It is a most important feature for this design because of the extreme effect low frequency reflected waves have on the drivers' acoustic properties. All other improvements are nil if the room alters the effectiveness of the delivery.

Another advantage allowed by the present invention is the use of lower mass drivers for the reproduction of low frequencies. Mass is an impediment for the signal to control the direction of the driver cone motion. The start-stop and change of direction for a driver cone is directly related to mass. Lower mass drivers generally are much less expensive than the large heavy drivers normally used for low frequency sound reproduction.

Still another advantage offered by the proposed invention is the extremely small driver cone travel in the subject enclosure design. This reduction in diaphragm travel allows for extremely fast execution of wave motion resulting in proper fundamental-harmonic relationships with the drivers operating in the adjacent higher bass frequency range. Low mass cones with little required cone travel are able to execute long wavelength signals in sync with the higher range driver. Distortion is also reduced if cone travel is kept low relative to the maximum available. This is a very important characteristic when designing larger systems of high capacity.

The subject invention inherently reduces the mechanical cabinet vibration normally associated with low frequency sound reproduction. Vibration produces bad sound at the expense of the good sound as the cabinet walls don't make good transducers. The flexing of the cabinet walls in a low frequency system is the result of unbalanced pressures on the driver cone and large panel areas. The subject invention inherently balances the pressure exerted on the opposing sides of the driver cone to reduce mechanically transmitted vibration to the enclosure walls. The subject invention inherently requires the use of smaller enclosure structures that generally won't need additional bracing to reduce vibration. This inherent vibration reduction allows for inclusion in sensitive equipment such as television sets or computers using plastic injection or other mass construction methods. Such vibration can cause modulation of the electron beams at certain low frequencies in some video displays or premature component failures.

A most important aspect of the subject invention is the low cost associated with production. Although it is possible to spend larger sums for aesthetics or more robust professional construction the basic application for bass reproduction preclude the need for complex and costly structures. The lower cost and ability to integrate the technology into existing structures allows for mass-market embedded applications for improved bass function in commodity products.

### BRIEF DESCRIPTION OF DRAWINGS

FIG. 1 is a side cross-section of a VARTL driver-woofer enclosure assembly constructed in accordance with and embodying the features of the present invention.

FIG. 1A is side cross section of FIG. 1 in which the port has been replaced by a mechanical passive diaphragm (radiator).

FIG. 2 is a bottom cross-section view of FIG. 1 to show a different perspective of view to illustrate features not identified in FIG. 1.

FIG. 2A is a bottom view showing the passive radiator and its' surround mounted on the bottom panel opposite the baffle board and RRAWG.

FIG. 3 is a side cross-section detail view of the VARTL structure and driver relationship. This drawing shows elements not seen in FIG. 1 and FIG. 2.

FIG. 4 is a non-detailed side cross-section view of a dual version with drivers facing along a common wave-guide A structure of a VARTL/Reflex bass system. This drawing represents the use of multiple modules to improve the efficiency in the same bass range.

FIG. 5 is a non-detailed side cross-section of a dual driver hybrid VARTL/Reflex system using VARTL extensions to slot load the enclosure of the direct radiator driver to enhance the upper bass frequencies.

FIG. 6 is a non-detailed side cross sectional view of a dual driver hybrid VARTL/Reflex system using a separate VARTL coupled reflex system to enhance the efficiency of the upper bass frequencies.

FIG. 7 is a non-detailed representation of a multi-cell VARTL/Reflex system using a plurality of tuning frequencies in order to optimize the operating range of each module. This arrangement focuses the driver in each module to operate in the minimum diaphragm excursion range to cover their respective frequency ranges using only the port outputs.

FIG. 7A is a representation of the typical overlap in frequency ranges of the system of FIG. 7.

FIG. 8 is a graphical illustration of the effect of the VARTL on the impedance of the driver to illustrate the standard reflex system and the effect of the VARTL.

FIG. 8A is a graphical illustration of the effect of the VARTL on the frequency response of the driver to illustrate the standard reflex system and the effect of the VARTL.

FIG. 9 is a graphical illustration of the effect on the impedance of varying the throat area of the VARTL to achieve critical damping.

FIG. 10 is a graphical illustration of the effect of the VARTL only on the driver impedance to show the effects of the VARTL with and without certain features.

FIG. 11 is a graphical representation of the required fundamental-harmonic structure of a typical low frequency wave.

FIG. 11A is a graphical representation of a subwoofer curve shaped using electronic filters. The unshaped curve will resemble that of FIG. 8A curve (67). It is shown in conjunction with the curve of a typical loudspeaker requiring bass extension and the overlap range.

FIG. 12 is a graphical illustration of the frequency response of a miniature version of the VARTL/Reflex system in a 0.022 cuft enclosure.

FIG. 12A is a graphical illustration of the effect of VARTL on the impedance of the miniature version of the VARTL/Reflex system of FIG. 12.

### DETAILED DESCRIPTION

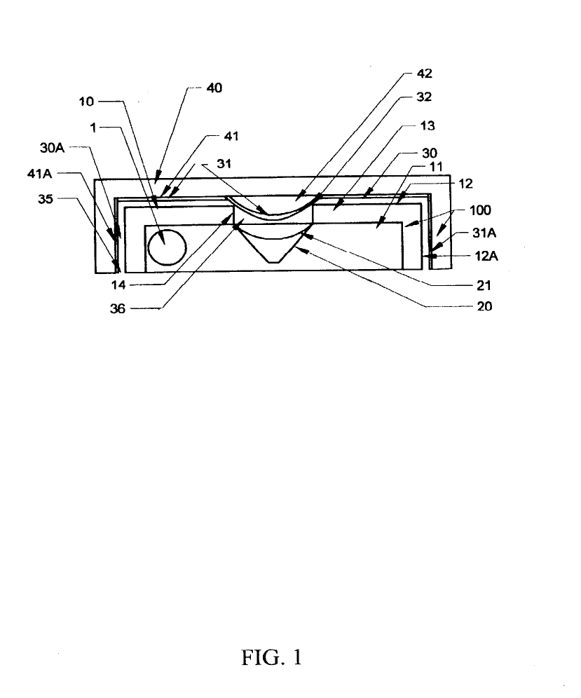

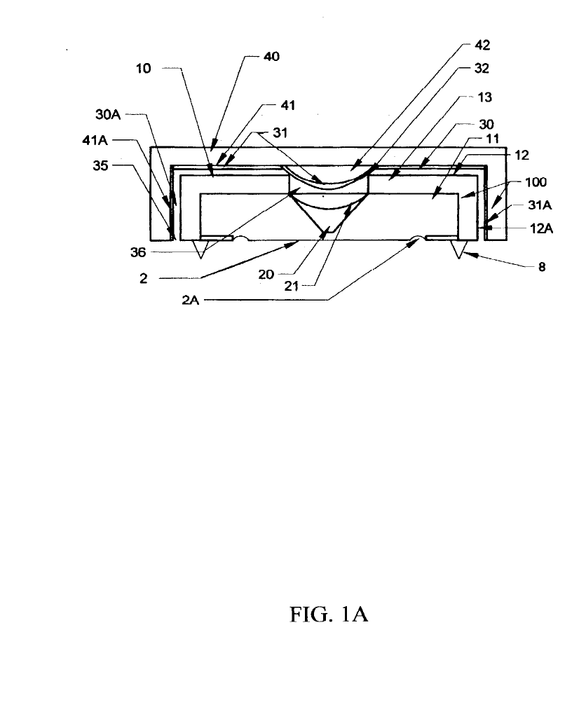

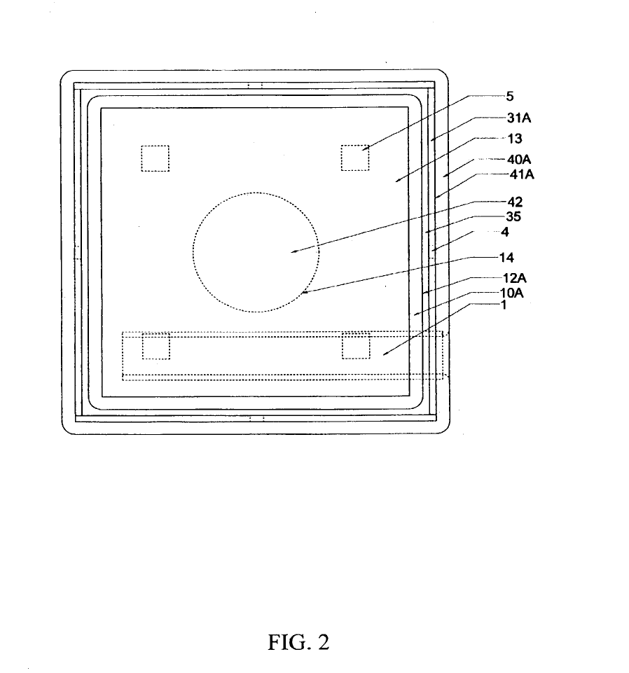

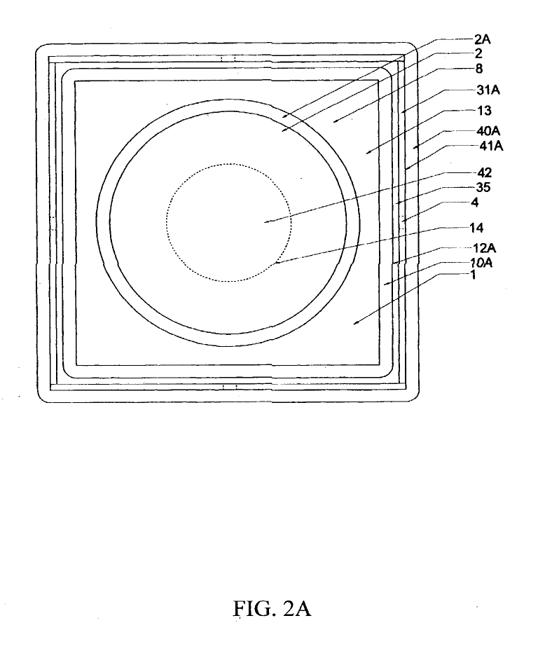

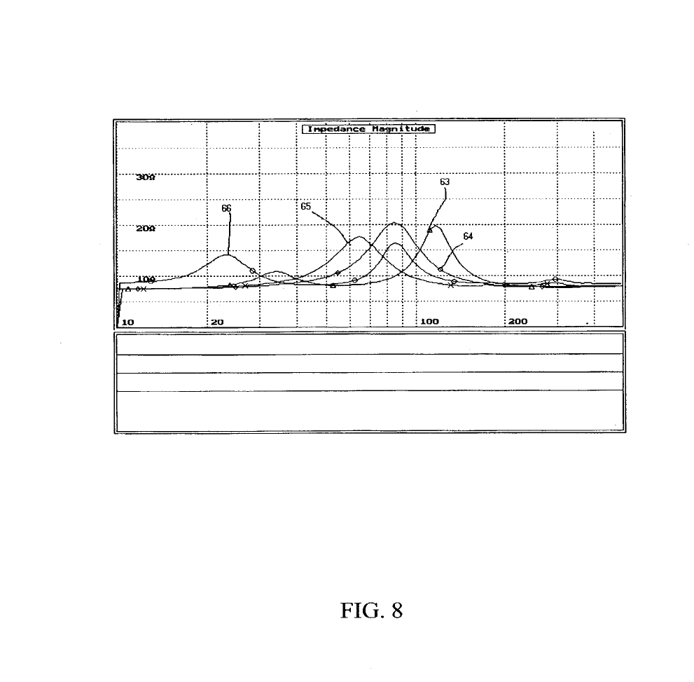

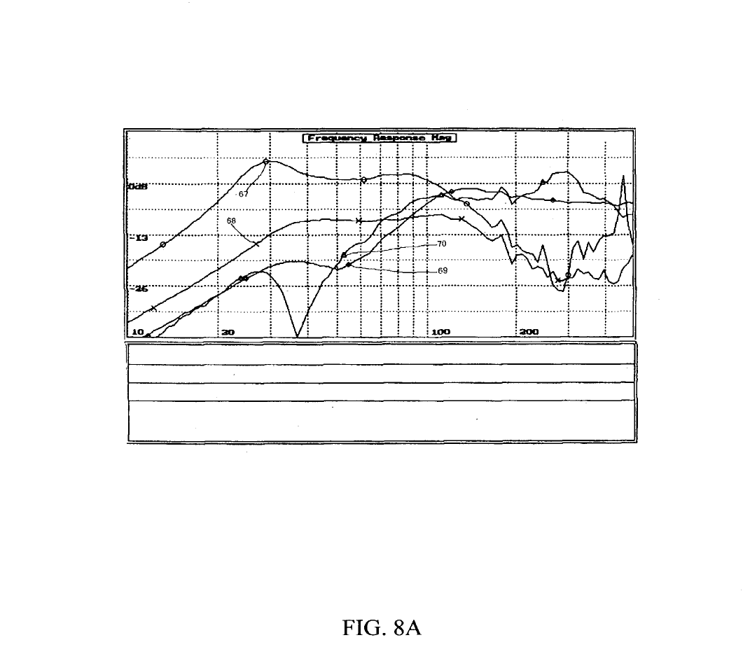

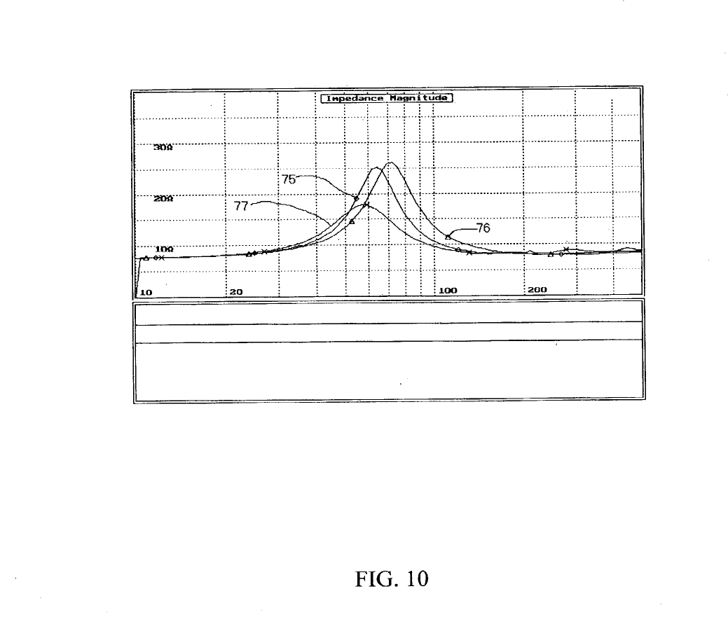

FIG. 1 represents a cross section of a side view of the preferred embodiment. The Virtual Acoustic Radial Transmission Line hereinafter called VARTL 30 is combined with a Reflex Enclosure 10 to optimize the acoustic resistance of the driver 20. The combined acoustic systems 100 allows almost any diameter driver 20 to be optimized to produce quality deep bass sound with an efficiency near the normal mid-band level. The VARTL/Reflex bass system 100 is a constant pressure dynamically closed acoustic system. The bass frequencies can be divided into two ranges with frequencies below 50 Hz being considered sub-bass and bass above 50 Hz-250 Hz as bass. The preferred embodiment can be constructed to optimize the acoustic impedance for small (3″) through large sized low mass drivers to produce the full range of bass frequencies. The efficiency will vary with size as will power handling for smaller to larger drivers. The Reflex Enclosure 10 can be tuned to produce the desired range of bass frequencies by adjusting the length of the port 1. FIG. 1 and FIG. 2 provide different views of the port to show its dimension. FIG. 2 indicates spacers (4) and (5) as a means of separating the wave-guides A 41,41A and wave-guides B 12, 12A the appropriate amount and are by no means inclusive as the only means of accomplishing this task. In FIG. 1 the wave-guide structures of the VARTL 40, 13 basically determine the thickness of the wave-guides and will vary with construction materials and design requirements. These structures 40,13 must be structurally stiff when employed in the VARTL/Reflex system 100 but not to the degree generally required for construction of typical bass systems. The smaller relative dimensions and balanced pressure operation of the VARTL/Reflex system 100 reduce the bending moment for any given construction material of a specified thickness. The VARTL 30 is created by lining a portion of the space between the wave-guides 41, 12 and 41A, 12A with a suitable Alternate Density Transmission Medium hereinafter called the ADTM 31. The Radial Right Angle Wave-Guide hereinafter called the RRAWG 42 is responsible for introducing the driver cone 21 modulated wave energy into the VARTL 30 by way of the semi-compliant air mass 36 directly in front of the driver. This air mass 36 formed by the boundaries of the driver baffle hole opening 14 and the thickness of that opening communicates the wave energy from the driver to the throat 37 of the VARTL 30. It is called semi-compliant because it must maintain some degree of stiffness (compliance) as it transfers energy to the throat of the VARTL but the predetermined throat area 37 establishes a rate in which wave energy can pass preventing compression of the compliant area 36. This wave energy is basically non compressible and terminates at the terminus 35 however delayed and with an altered velocity line from that of the port. This exit area 35 for the wave energy is not resonant with any other aperture of the system and terminates the VARTL 35 into the ambient. The volume of air 11 inside the reflex enclosure 10 is semi-compliant and reacts with the non-compliant air volume in the port 1 at the box resonance as determined by their air volume ratio. This is a normal function of a reflex speaker however the air volume 11 in the enclosure 10 is the minimum air volume 11 required to house the driver 20 and the port 1. This is not an optimum air volume for conventional T/S design and those formulas cannot be applied to the VARTL 30 design. Certain T/S parameters offer a means of qualifying a driver 20 for operation in a VARTL/Reflex 100 environment. The impedance curves of FIG. 8 best explain the reaction of the driver to this enclosure environment. The driver 20 has a specific resonance feature un-mounted in free air as illustrated by curve 64 of FIG. 8. In free air the driver 20 encounters no resistance to motion other than that of the adjacent air molecules and the drivers compliance and total moving mass. Driver 20 damping is controlled almost entirely by the suspension system for the cone 21 and the adjacent air mass. When a limited air volume 11 is placed behind the driver cone 21 the compressive effect of the limited air volume causes the impedance of the driver 20 to increase as indicated in FIG. 8 curve 63 This action is the result of the compliant air mass 11 behind the driver lowering the compliance of the driver causing a rise in its operating resonant frequency. The compliant air mass 11 in the box resonates with the non compliant port 1 air mass to create box loading indicated by the valley between the port and driver resonance peaks of curve 63. The Q of an acoustic transducer is the ratio of reactive to resistive energy and basically determines the quality of the sound. The Q is higher when the driver is placed in the reflex box only with the box frequency at 52 Hz as indicated by the narrow yet steep driver impedance in FIG. 8 curve 63. The impedance peak of the port in FIG. 8, curve 63 is at 35 Hz and indicates by its' height inadequate cabinet volume to efficiently resonate with the enclosure. At the port 1 resonant frequency the driver 20 is not controlled by the signal with low frequencies unloading beginning at 48 Hz. A standard reflex system 10 provides no loading mechanism for the driver 20 below the box resonance and is one of the several reasons for an impure sound delivery for these types of systems. The system damping is too low for the driver 20 and too high for the port 1 resulting in poor sound quality. The driver 20 will have the loudest sound in this instance at its' resonant frequency of 125 Hz. In a typical reflex system the enclosure volume or driver mass would be increased to compensate for this problem. Typical damping methods for the driver 20 are the addition of fibrous material into the enclosure, which also dampens the internal air mass 11 and reduces efficiency. The driver-port phase relationship cause the design of conventional reflex enclosures to result in artful subjective cover-up practices. The lack of cone loading below the box frequency and the ambiguous phase relationship between the driver 20 and the port 1 cause compromise in design execution. The increase in resonance frequency caused by mounting the driver 20 in the reflex box 10 is the direct result of inadequate Vas (equivalent box volume) for that driver. It is for this reason that most subwoofer drivers 20 are mounted in relatively large enclosures and have high moving mass. The conventional subwoofer driver 20 typically has a very low free air resonance for this very reason. If the free-air resonance is very low then it will rise to the design frequency when installed in the enclosure 10. The added mass to create the low frequency of resonance is an undesirable characteristic when control of motion is required while the unrelated air masses facing the cone 21 further complicate transient response. In the present embodiment the driver 20 has a relatively high frequency of resonance [85 Hz] this is not low enough to be considered for typical sub-woofer use but is ideal for use in the present invention. The T/S parameter Vas is a very important unit for conventional reflex design but it will be seen that the VARTL/Reflex 100 synthesizes this parameter to allow low frequency operation with smaller drivers in smaller enclosures. The VARTL 30 is an aperiodic (non-resonate) environment intended to provide an acoustic load on the front side of the driver 20 at all bass frequencies even when the reflex enclosure 10 is not loading the driver. In FIG. 1 the free air impedance is indicated by curve 76 representing only an air and suspension load. The curve 75 of FIG. 10 illustrates the effect on the drivers' impedance when only the RRAWG 42 and Wave-Guides A and B 41,42 are disposed in front of and around the driver. The total air masses of the VARTL 30,30A add to the driver mass to cause a slight damping effect and a noticeable shift in frequency as indicated by curve 75. Critical damping and a further reduction in resonance are achieved when the ADTM 31,31A is mounted on wave-guide A 41 as indicated by FIG. 10 curve 77. The total spacing between Wave-Guides A and B 41,12 in the preferred embodiment is 0.625 “and the thickness of the ADTM is 0.25”. These dimensions will vary some but always remain near 1:1 with the VARTL area 30,30A and therefore non-resonant as air masses even without the ADTM 31 lining. When the driver 20 is placed in this environment 30 the total non-compressible air mass disposed in front of the cone reduces the resonant frequency of the cone as illustrated by FIG. 8 curve 77. When mounted in the VARTL the impedance characteristic is modified to show a damped condition while the resonant frequency of the driver 20 is lowered to 65 Hz. This is indicative of non compliant air mass presented to the cone and is the total VARTL 30,30A modified reactive air volume. The net effect on driver impedance when combining the VARTL 30 with the reflex enclosure 10 is FIG. 8 curve 66. The compliance of the reflex enclosure 10 mounted driver 20 is lowered and this is normalized by the additional air mass of the VARTL. The resultant curve 66 is the operating impedance for the system and indicates the driver 20 impedance has returned to its” free air frequency and is critically damped. This is an ideal operating condition for the driver 20 and this form of loading is termed isobaric, meaning a constant dynamic pressure is seen on the cone 21 as it completes the work cycle. Air pressure is equal on each side of the cone 21 when at rest and this condition is essentially maintained dynamically as the cone 21 moves in either direction from its” rest position. Conventional isobaric loading requires an additional driver to maintain a constant pressure on the main driver 20. This conventional approach is far from ideal with a myriad of compromises involved using two drivers in this manner. In the VARTL 30 operating environment the driver cone 21 will respond symmetrically to each cycle improving transient response. In electronic amplifier circuits this is known as bias, in which the circuitry is conditioned to respond to the most minute changes in input signal, overcoming the non-linear portion of the amplifier device curve. When the signal demands a change in position the cone 21 will move efficiently in either direction since the driver 20 doesn't have to overcome any nonsymmetrical resistance even its” own suspension compliance. The driver only requires either a positive or negative signal condition however minute to overcome its” balanced quiescent state.

The listening quality is considerable improved at low listening levels and the ears' apparent sensitivity to the added bass is obvious through repeated confirmations with different locations, equipment and listeners. This defies the position of earlier findings [1933] that excessive volumes must exist for the ear to maintain sensitivity to low frequencies. These earlier findings are apparently correct when developing bass conventionally attesting to the high volume level generally required for enjoyment of sound.

This isobaric condition will be offset for any other driver with parameters not optimized for a given VARTL/Reflex system 100 especially resonant frequency and Q. The transient characteristic will vary slightly from ideal when driver parameters are not optimal for a given VARTL 30 assembly. The advantages of the VARTL 30 are maintained if a modest driver mass offset causes operation at near free air resonance.

The VARTL/Reflex system 100 actually synthesizes an increased reflex enclosure 10 volume while maintaining ideal loading characteristics for the cone 21 at lower frequencies. The operating impedance curve 66 in FIG. 8 has a broad box-loading range with a lower box frequency (38 Hz). This condition can be established for virtually any low mass full range driver 20. It is an object of this invention to eliminate high driver 20 mass as a requirement to obtain an effective low frequency transducer system.

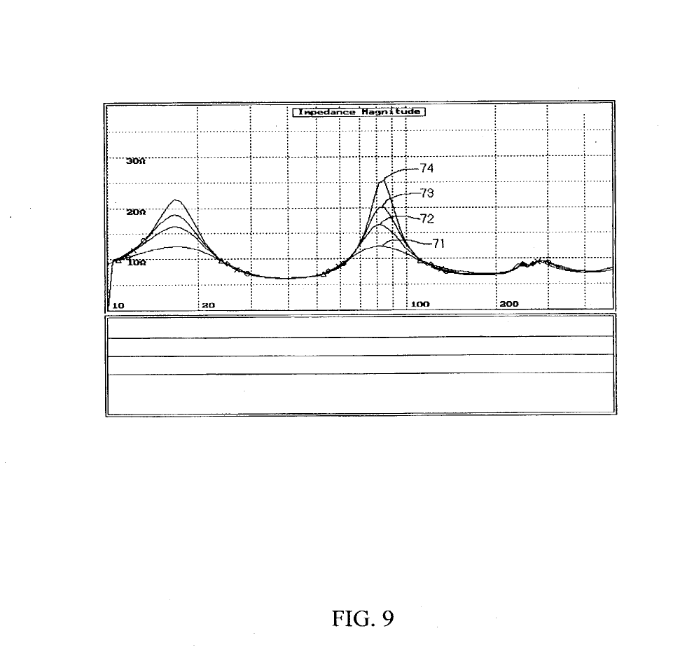

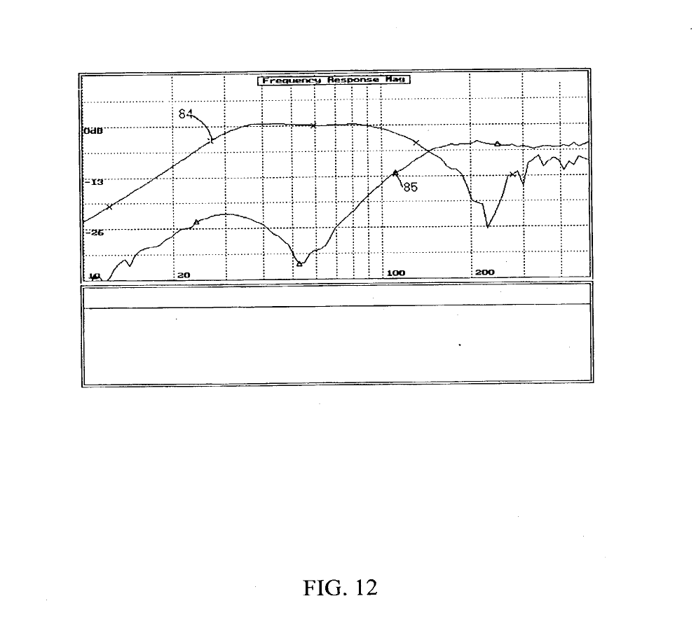

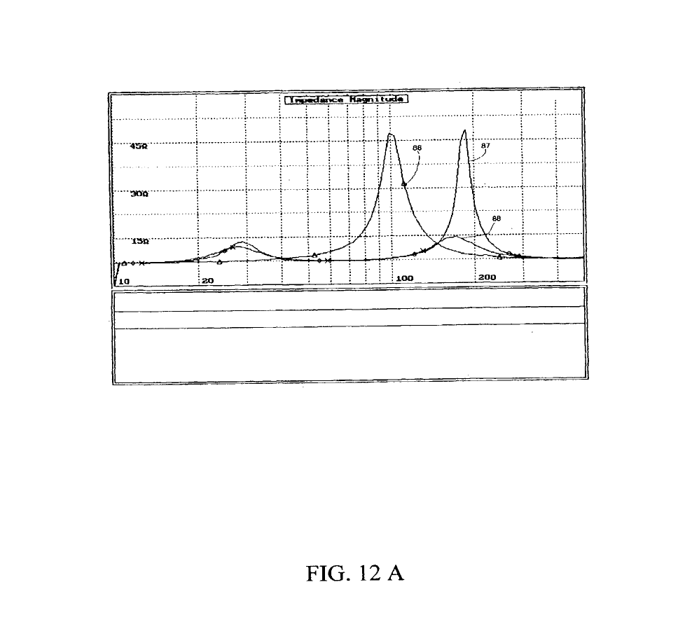

The driver cone 21 must maintain a constant velocity during the execution of a wave. The velocity is normally constant with frequency change however if there is a velocity change that is not due to a change in input signal then distortion results. The driver 20 modulates a compliant air mass 36 directly in front of the cone 21. This compliant area 36 transfers the mechanical motion of the cone 21 as a molecular air motion into the VARTL throat area 32. The resistive/reactive area of the throat 32 is defined to allow the wave energy to pass into the VARTL 30 at a constant rate even though the effective driver cone 21 area is less at the lower frequencies. It is this ability to provide any given driver 20 with constant velocity loading at low frequencies that allows it to modulate the inefficiently tuned port 1 over a broad range. The resistive area 32 of the VARTL should be optimized for a given driver 20 to provide proper damping for the reflex system air mass 11. The damping characteristic of the VARTL 30 is transferred directly to the compliant air mass 11 of the reflex enclosure 10 through the driver cone 21 and is responsible for the increased port peak air volume. This fact is illustrated in FIG. 9 as a small adjustment of the VARTL throat area 32 provides for large changes in both driver and port Q therefore eliminating any need to use internal sound absorption material to control damping. It can be seen that the action is to dampen the driver 20 slightly more than the port 1 until critical damping is reached (curves 72 and 74) wherein the driver impedance is reduced more than that of the port. This action is illustrated even more with the micro driver of FIG. 12. The configuration is the same as that of FIG. 1 however the dimensions are small relative to a 3″ driver. The dimensions are empirically chosen to allow the driver 20 and port 1 to physically fit into the reflex enclosure 10. A minimum internal air volume 11 is that which will allow the driver assembly 20 and the length and thickness of the port 1 to occupy the reflex enclosure 10. The total enclosure air volume is less than 0.022 cu ft far to little for any known bass alignment. The free air impedance of the driver 20 is 100 Hz with a very high Q as indicated by FIG. 12A curve 86. When this driver 20 is mounted in a small reflex enclosure 10 tuned to 55 Hz the Q and resonance frequency gets higher as evidenced by the narrow yet still high driver 20 impedance peak shown by FIG. 12A curve 87. The VARTL 30 used to dampen this peak is very small in area FIG. 12A curve 88 and does not reduce the drivers' resonance (via air mass) as much as that in FIG. 8 curve 65. The driver is not operating at its” natural frequency when configured with VARTL 30. The Very High Q of the driver 20 would cause severe ringing and poor sound operating in the reflex enclosure only 10. FIG. 12A curve 88 indicates that the use of a small area folded VARTL 30 as the primary loading element provides critical damping (47\hat{l}© to 15î©) of the driver 20 while only slightly correcting the port 1 impedance (14\hat{l}©to 10\hat{l}©). This correction illustrates the ability of a very small VARTL 30 area to provide critical damping for the entire system without introducing damping material into the enclosure air mass 11. The frequency response of the micro VARTL/Reflex system is indicated in FIG. 12. The constant loading allows impedance matching of a 3″ driver to produce frequencies to less than 30 Hz at near its” mid-band levels. The driver 20 output curve 85 is 35 db lower than the port 1 output curve 84 at resonance while the VARTL 30 maintains a flat response for the port output 84 in the lower bass range and the driver output 85 in the upper bass ranges as indicated by the two curves 84,85.

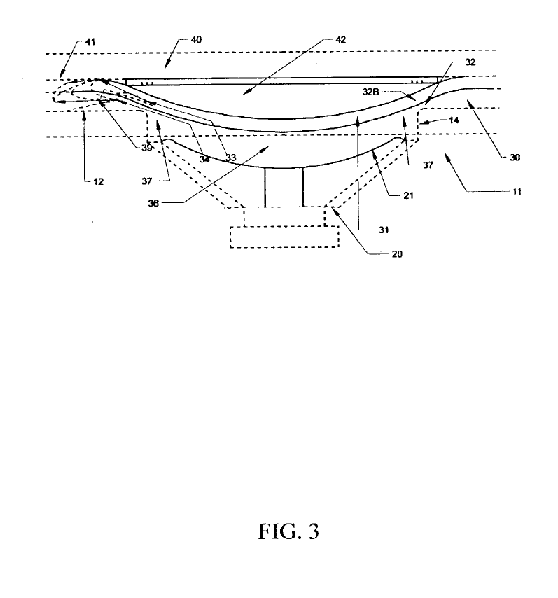

FIG. 3 provides a side cross-section detailed view of the VARTL 30 construction and explanation. The RRAWG 42 is a convex [preferred] formed structure located directly in front of the driver cone 21. The RRAWG 42 is at the center of the VARTL 30 secured to wave-guide A 41 and serves to guide the pressure wave of the cone 21 into the resistive- 32 reactive 32B area of the VARTL throat 37. The VARTL 30 is formed by Wave-guides A and B 41,42 in conjunction with the ADTM 31 which is a specific thickness of porous material secured to wave-guide A 41 using adhesive or other means to prevent physical movement. This creates a wave-guide with a continuously expanding radial area from the driver 20 periphery in which a portion of the space is occupied by air and the other by less air and a relatively dense porous material 31. The material 31 used in the preferred embodiment is urethane foam sheet that is partially reticulated and having an open cellular structure. While the absorptive properties of acoustic materials generally assume incident angles approaching 90Â°, their use when introducing sound energy at only narrow angles allow for a cumulative effect of the properties. This is analogous to a friction surface for the air molecules traversing it. The ADTM 31 is chosen to have a density much greater than that of static air density (1.18 kg/mÂ³) and in the preferred embodiment that density is 32 kg/mÂ³. The cumulative dynamic [motional] density in the VARTL is much greater than that of air as indicated by FIG. 10 curves 77 with the ADTM medium and curve 75 with air mass only. This cumulative density will vary with VARTL dimension but as seen by the curves of the extremely small micro 3″ system of FIG. 12 and FIG. 12A a small radial area is very effective in controlling the critical damping of the driver. Greater expansion of the VARTL area also causes a corresponding shift down of the drivers resonance frequency as the wave energy traverses this dynamically reactive radial area as indicated by FIG. 8 curve 65. The actual damping factor is consistent with expanding radial area as is shown by the damping consistency between the micro sub graph of FIG. 12A curve 88 and that of the miniature sub of FIG. 8 curve 66 where both impedance graphs show proper damping. In FIG. 3 it is seen that the compliant air mass 36 in front of the driver is essentially the air volume within the baffle hole opening 14 [Diameter-Thickness] of the driver 20. The wave energy 33 of the compliant air mass 36 interacts initially with the ADTM 31 material as the complimentary concave shaped cone 21 pushes/pulls the wave into the ADTM 31 in front of the cone. The porous material 31 immediately interacts with the wave energy 34 and begins to deflect it in infinite directions throughout its cellular structure where finite levels of heat are generated in delaying and absorbing the wave as it traverses through the radially expanding VARTL 30. The wave energy 34 is also guided toward the resistive throat area 32 where the wave is allowed into the VARTL throat 37 The ADTM 31 allows a delayed portion of the wave energy 33 [reactive] to pass into the VARTL throat 37 while simultaneously a portion of the wave energy 34 enters through the resistive throat area 32 The air molecules within the compliant area 36 are responsive to the wave motion created by the cone 21 movement and are linked by that displacement and the property of a fluid termed viscosity. The reactive (delayed) portion of the wave energy 33 drags the resistive portion of the wave energy 34 by viscous means and causes the resistive portion of the wave to follow the delayed portion 39 in alternating directions through the VARTL area. The constant radial expansion assures that there is no compression while the wave speed is slowed dramatically drastically shortening its wavelength. The driver 20 sees a shortened wavelength with the same period and loads for a longer portion of the wave cycle. The speed of the wave is reduced to<200 ft/sec in the VARTL 30 to maintain driver cone acoustical contact with the wave energy at very low frequencies. The exit velocity is the same at the terminus 35 and port 1 however the velocity time line has been shifted by the VARTL and the drivers front side wave output is effectively reduced especially in the lower frequency ranges. The VARTL is very effective as illustrated with the 3″ system where only inches are required to effectively dampen a high Q driver for operation with VARTL technology as a subwoofer. The ratio of reactive area 32B to resistive area 32 in the VARTL 30 environment is critical to proper damping and delay as wider wave-guide 41,12 spacing will prevent forced interaction of the resistive 32 and reactive 32B areas and the wave energy will flow towards the path of least density, that of air. A resistive area that is too narrow relative to the ADTM density will over damp the driver and prevent air flow through the VARTL. The VARTL Throat Gap 32,32B and the VARTL 30 isolate the driver 20 from the ambient reflected signals that normally interact with the cone. This concept has been termed an acoustic diode and has no known equivalent concept in audio speaker engineering. This isolation of the driver 20 allows for greater acoustical separation of driver front wave and the port 1 acoustic output. The acoustic interaction of the driver 20 with the port 1 or passive radiator 2,2A help limit the depth of the null in conventional reflex woofers. A deeper null reflects an ideal characteristic at box resonance when little motion is required by the driver cone 21 to produce output from the port 1. In the preferred embodiment additional compliance losses are compensated for by the natural isobaric environment for the low mass driver cone allowing for a null approaching infinity FIG. 8A curve 70. The graphs of FIG. 8A illustrate the increased output from the port (curve 67) due to the impedance matching by the VARTL 30 with maximum output occurring<30 Hz. FIG. 8A curve 70 illustrates that the driver output by way of the VARTL is always less than that of the port even at upper bass frequencies. The dynamic range gain is obvious with a much greater separation between the driver FIG. 8A curve 70 and port output FIG. 8A curve 67 at lower frequencies. The VARTL 30 provides over 40 db separation between driver and port outputs at box resonance. The reflex only system FIG. 8A curves 68,69 show only 13 db separation and the drivers' output 69 is greater than the port 68 in the most audible bass ranges. The port output is 12 db less than the VARTL/Reflex system curve 67 It is this extreme reduction of cone motion and driver impedance matching that allows the VARTL/Reflex bass system of FIG. 8 using a 5″ driver 20 with 6 grams of mass and 3 mm maximum cone travel to produce 90 db+ room volume levels at 30 Hz with relatively low distortion.

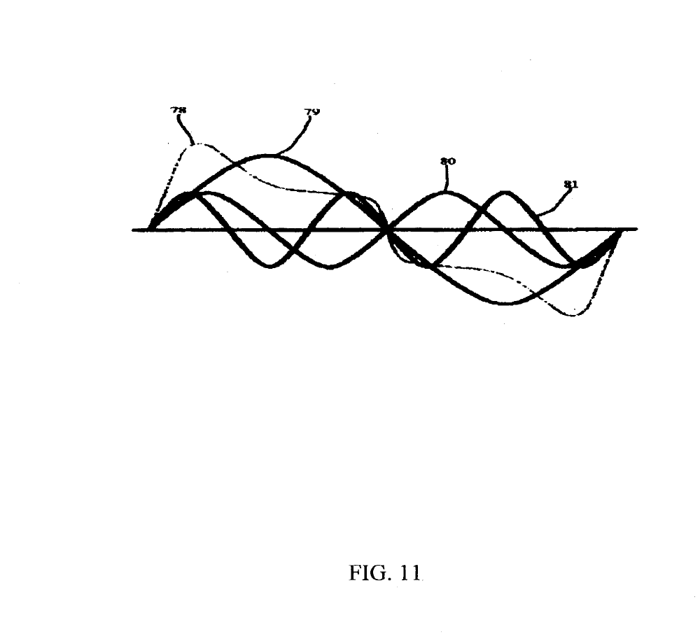

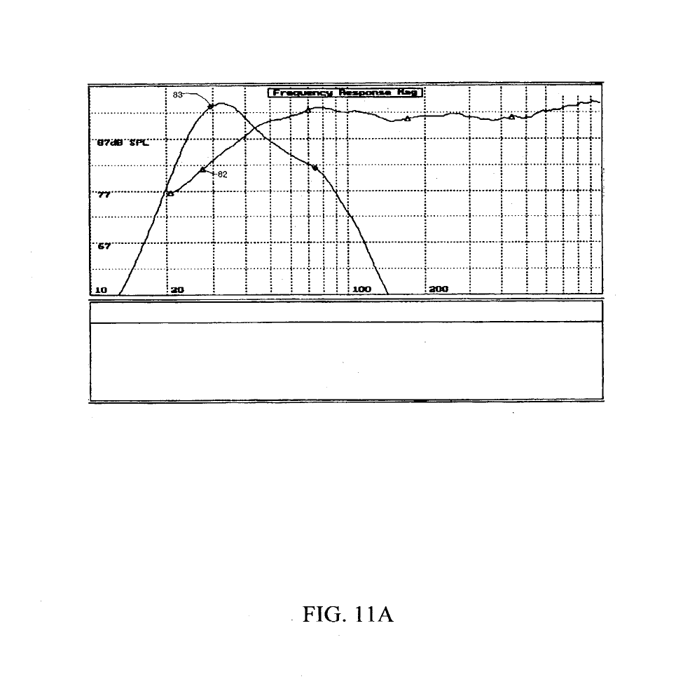

It is also this extreme reduction in cone motion that provides a platform that launches long wave length signals as quickly as the higher frequency bass driver to allow for proper timing. All sounds with the exception of pure tones consist of a fundamental wave and a series of harmonic waves that are generally multiples of the fundamental. The instantaneous snapshot of a sound might look like FIG. 11. Wave 79 represents the fundamental wave while the second and third harmonics are curves 80, 81 respectively. All of the waves are produced simultaneously and create a resultant wave 78A which is a composite of the three separate waves superimposed on each other. If the fundamental wave is low in frequency and reproduced through a separate bass system FIG. 11A curve 83 it is important for the wave to be free of any timing errors if the resultant wave is to be reconstructed at the ear as the original signal. Although all sound sources travels at the same speed in a air the use of conventional massive subwoofers large or small with long cone travel and unbalanced forces on the cone will always result in a time distortion of this resultant wave FIG. 11 curve 78. The sound from the sub woofer will not be in sync with the sound from the woofer because the subwoofer driver has a delayed mechanical response time relative to the bass driver and slower settling times. The reflected signals from the room further complicate the ability to reconstruct the resultant wave 78 accurately by modifying the radiation resistance of the drivers cone. The low cone mass and extremely short cone travel experienced with the VARTL/Reflex bass system 100 allows accurate reconstruction of the fundamental-harmonic resultant wave FIG. 11 with typical rooms and speakers. It is the intention of the subject invention to allow for proper restructuring of independent fundamental and harmonic sources to provide the resultant waveform curve 78 of the original source. Achieving quality bass performance without mass reduces the efficiency of the system relative to high-mass bass systems. The question of efficiency is moot when considering low frequency output from smaller drivers not even considered for such a task when conventional technologies are applied. The sound must be correctly blended at lower levels in order to achieve quality at higher levels.

FIG. 1A illustrates the substitution of a mechanical passive radiator 2 suspended by a resilient surround 2A for the port 1. FIG. 2A illustrates a typical passive diaphragm 2 mounted on the bottom panel 8 of the reflex enclosure with 2A indicated as the resilient support. The general operation of ported 1 or passive radiator 2,2A is the same however there are advantages for the passive radiator in some applications and for the port in others. Port noise or turbulent air leaving the port can contribute as a form of distortion and this is eliminated when using the passive radiator. The additional mass of the passive unit alters its' mechanical compliance and can compromise the active driver attack and decay translation unlike a port with only an air mass. Air moving air will produce the quickest response and that would be the ported version. A prototype VARTL/Reflex system 100 using a 3″ driver 20 and 4″ passive radiator 2,2A substituted for the port 1 in the system of FIG. 12 and FIG. 12A has been successfully constructed with performance similar to that of the ported version. The cabinet dimensions are 5″×5″×2.5″ with a internal volume of 0.02 cu. Ft. The standoffs 8 shown in FIG. 1A provide clearance for the vibrating passive unit 2,2A if it is near the floor or other surface. The passive radiator 2,2A has a mechanical mass and compliance that cause it to interact with the mass of air in the enclosure 11 to create a similar impedance curve [not shown] to FIG. 8A curve 64. The passive radiator 2,2A has a tendency to unload faster than a port 1 but is supported below resonance by the VARTL 30 to improve the quality of this type of reflex system. The acoustic impedance match provided by the VARTL loaded internal driver 20 enhance the speed and decay of the radiator and allows for a lower mass passive diaphragm 2,2A.

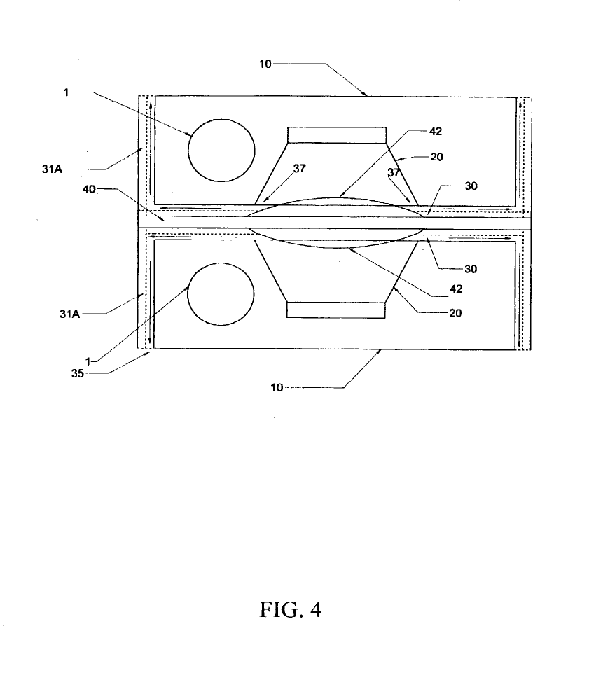

A single VARTL/Reflex bass module 100 generally provides adequate SPL for a particular application. There are situations when additional SPL would be desired but the quality of the bass sound must be maintained. It may be that a particular diameter driver 20 provides the desired sound character for a particular situation. It is known that adding two coherent sound sources increases the level by 6 db when placed in close proximity. This is the equivalent of quadrupling the power to a single source, which is not practical and would require a massive driver 20 to dissipate the power. If the sound sources are not coherent the advantages of multiple sources is lost, as the sound will have an incoherent result. The VARTL/Reflex bass system 100 is a coherent source of sound allowing the port output to coherently add to another VARTL/Reflex source. The lower cost of the drivers 20 is used to an advantage when increasing the SPL is desired. It is easy to place two distinct systems together for this increase in SPL however the cost and complexity would be greater than combining two or more modules into a single unit as in FIG. 4. The size advantage is maintained and the cost would be less than two separate units giving this product a distinct improvement in SPL over a single unit while maintaining the other advantages of the VARTL/Reflex. The increased sensitivity and power handling would also allow for decreased distortion when played at similar levels as a single unit maximum. The methods of construction can vary with the application requirements with the inherent advantage of reduced vibration for construction material selection flexibility.

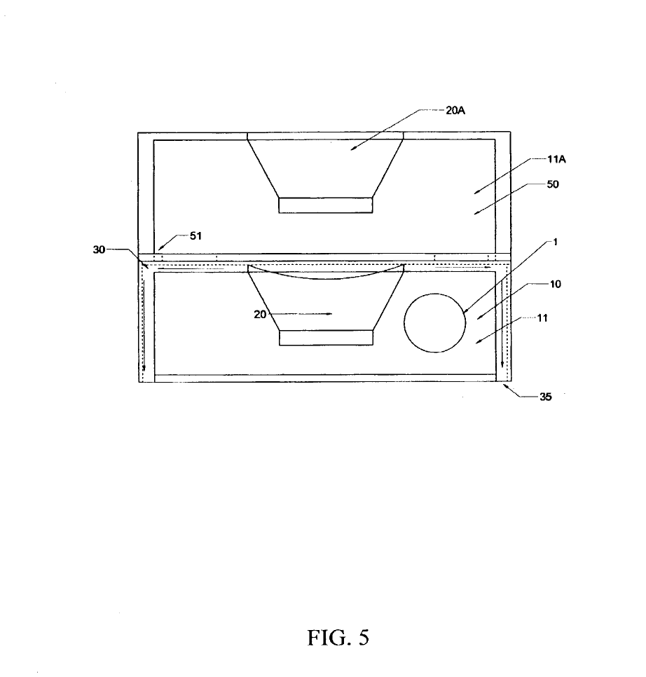

In matching the acoustic impedance of the driver for lower bass frequencies using VARTL 30 the efficiency is reduced in the upper bass ranges. Some speaker systems will have adequate upper bass and not need augmentation in this range. There are however speakers that have inadequate sound output in the upper bass ranges. It would be desirable to increase the output level of the VARTL/Reflex bass system in the upper bass ranges while maintaining a quality synchronized sound. FIG. 5 is a VARTL/Reflex system that uses a second driver 20A optimized to operate in the upper bass ranges. It is normal for the VARTL/Reflex system 100 to operate in conjunction with other speakers in the upper bass ranges. The inclusion of a second driver 20A to augment the upper bass ranges of the VARTL/Reflex system 100 allows for acoustic coupling of the drivers 20,20A for more coherent operation. FIG. 5 illustrates such an augmentation system when a second driver 20A is mounted in a separate enclosure 50 and radiates its sound directly into the ambient as normal. The internal air mass 11A of this cabinet would load into the VARTL 30 using slots 51 at the enclosure edges. This would prevent pressure buildup in the second enclosure 50 while isolating the rear wave for the shorter wavelengths of the upper bass ranges. Appropriate electrical or electronic networks would be use to match the two drivers 20,20A level and frequency of operation. This execution of the subject invention could be the foundation for a single piece full range loudspeaker only requiring a tweeter for full range operation.

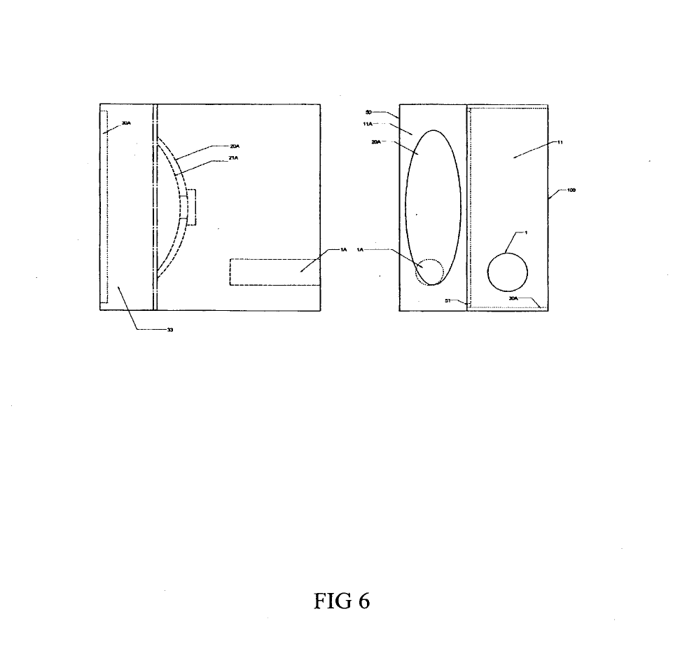

FIG. 6 illustrates the use of a second resonant system to generate the enhanced upper bass output. In this case an oval driver 20A is employed to minimize the required cabinet 50 thickness: The front of the driver is housed in an enclosure that is vented into the VARTL 30A of the host VARTL/Reflex system 100 This provides aperiodic loading for the driver as it resonates the port 1A at its rear. The VARTL 30A is primarily used to isolate the front of the cone 21A without pressure buildup while the reflex air mass 11 is tuned to a higher bass frequency. This arrangement will reduce the cone motion for the upper bass augmentation allowing the use of less expensive drivers and for lower distortion.

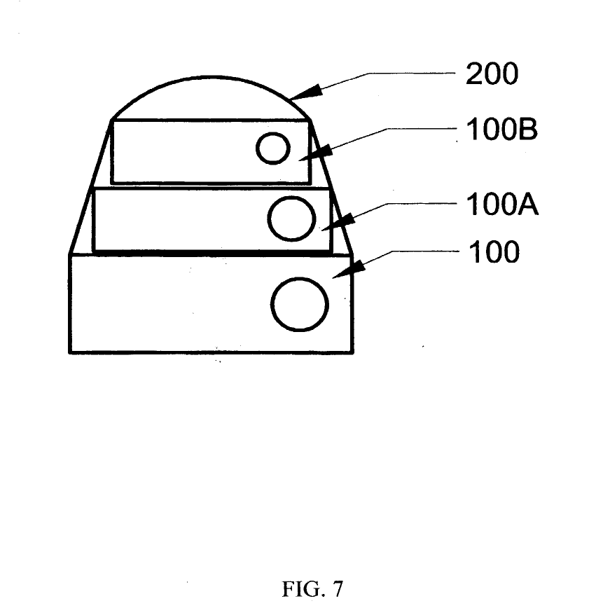

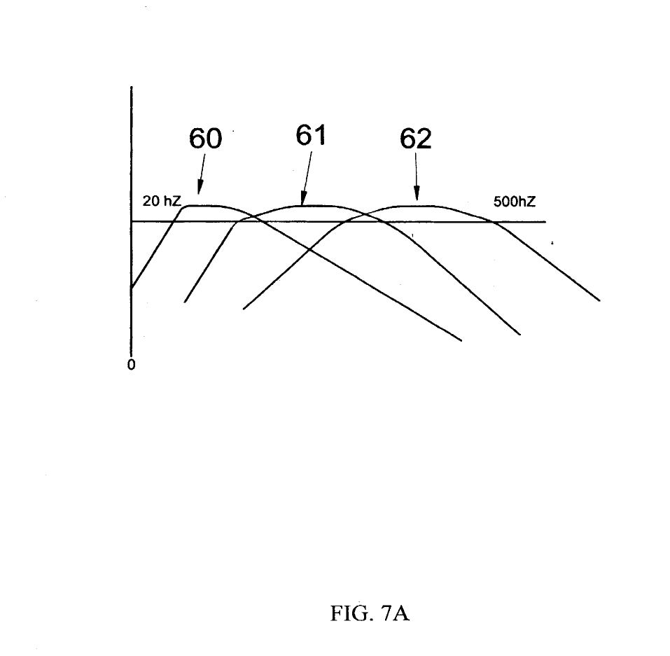

FIG. 7 illustrates the use of multiple cell VARTL/Reflex units that are tuned to different frequencies and constructed to be a specific distance apart. The housing 200 is indicated as means for holding modules in position and providing final dimension for the system. Each unit will be a fully functioning VARTL/Reflex bass system 100 with adjacent tuning frequencies from low to high. The modules are labeled A, B and C with the lowest frequencies being produced by module A 100 the mid-bass by module B 100A and the upper bass by module C 100B. Electrical or electronic networks are employed to match the outputs and provide proper frequency range for the each module. FIG. 7A illustrates a possible frequency response graph for a multi-cell/multi-tuned VARTL Reflex bass system. FIG. 7A curve 60 is for the lowest range, 61 represents the middle bass range and 62 represent the highest frequency range for the system. All modules will operate in the frequency range of minimum diaphragm excursion providing for increased output and lower distortion.

This application has described several ways of using the VARTL to enhance the low frequency response of dynamic loudspeakers. The VARTL/REFLEX 100 could be inclusive of structures intended for a different purpose such as panels of an automobile or television or another appliance or component. In such an environment the VARTL 30 would require only those structures that aren't a part of the main product and with a low vibration characteristic essentially become a integral part of that product. A VARTL/Reflex subwoofer could be integrated into the package shelf or door of a vehicle using very little space and using the larger un defined structures of the vehicle for portions of the VARTL 30 or reflex enclosure 10 volume. It is the principles of operation being defined here with many ways to exploit them being apparent and through closer examination becoming more obvious to anyone skilled in the art.

I claim:

1. A loudspeaker cabinet system (100) that provides improved bass/sub-bass response characteristics compromising: a cabinet (10), a dynamic driver (20) connected to a driver cone (21); a virtual acoustic radial transmission line (VARTL) (30) disposed around and in front of said cone of said driver to isolate said driver from reflected signals, said VARTL defined by a first wave-guide, a second wave-guide and a third wave-guide, wherein said second wave-guide is a radial right angle wave-guide (RRAWG); said first wave-guide (41) positioned proximate to and in front of said driver cone; said right angle wave-guide (42) positioned radially proximate to said third wave-guide (12) and generally between said first wave-guide and said third wave-guide; and an alternative density transmission medium (ADTM) (31) disposed between said first wave-guide and said third wave-guide, wherein said loudspeaker further contains a tuned port (1) in said cabinet.

2. A virtual acoustic radial transmission line, comprising a right angle wave-guide, ADTM and flat panel members, whereby said virtual acoustic radial transmission line improves the low frequency response of a bass-reflex loudspeaker and is positioned in front of the driver cone of said loudspeaker, and whereby said VARTL attenuated the front wave of a bass-reflex loudspeaker and radiates from at least one vent behind the driver cone.

3. The loudspeaker cabinet of claim 1, wherein said virtual acoustic radial transmission line comprises: said first wave-guide, said second wave-guide, said third wave-guide, and said ADTM, wherein said third wave-guide is defined by a baffle board (13) carrying a layer of said ADTM, wherein said baffle board cooperates with said first and second wave-guides to define VARTL dimensions and a throat area thereof.

4. The loudspeaker cabinet of claim 1 wherein the tuned port is replaced with said; mechanical passive, acoustically reactive diaphragm (2) affixed over said suitable hole opening on said Reflex enclosure (10,1) flat panel member via of said resilient surround (2A) to resonate in sympathy with said driver (20) included within said reflex enclosure.

5. A loudspeaker system comprising a VARTL and at least one dynamic driver connected to a driver cone, said dynamic driver capable of emitting a frontal pressure wave, whereby said VARTL introduces an acoustically reactive environment for the frontal pressure wave and is positioned in front of said driver cone of said loudspeaker, and whereby the frontal pressure wave intersects said alternate density transmission medium.

6. A VARTL having a first outer panel, the first panel having a center region and an outer edge, the virtual acoustic radial transmission line comprising a panel member, an alternate density transmission medium and a baffle board, whereby the alternate density transmission medium is introduced into the center of the VARTL.

7. The VARTL of claim 4, wherein the ADTM comprises sheet type open cell foam.

8. The VARTL of claim 5, wherein the ADTM is integrally molded into the first wave-guide of the VARTL.

9. A loudspeaker system, comprising a virtual acoustic radial transmission line, a cabinet having a plurality of walls, a box positioned substantially outside said cabinet and proximate to said plurality of walls of said cabinet, wherein said box is a wave-guide, said box having a plurality of corners and a plurality of walls, wherein said VARTL is folded generally between said plurality of walls of said cabinet and said plurality of walls of said box, and wherein at least a portion of said VARTL is positioned in front of the driver cone of said loudspeaker.

10. The loudspeaker system of claim 9, wherein said VARTL comprises a RRAWG, at least one flat panel member and an opposing positioned baffle board, whereby said a least one flat panel member is at least one said wall of said plurality of walls of said box and said baffle board is at least one of said plurality of walls of said cabinet, and wherein said RRAWG is positioned generally there between.

11. The loudspeaker system of claim 10 wherein an additional driver and enclosure is attached to said VARTL/Reflex system to augment upper bass frequencies and utilizes the folded extended walls of said VARTL to isolate the front and back waves of said additional driver.

12. The loudspeaker system of claim 11 wherein the internal air volume communicates with said VARTL to prevent pressure buildup and wave cancellation while said driver radiates directly into the ambient, frequencies other than bass frequencies.

13. The loudspeaker of claim 10 wherein two or more VARTL/Reflex systems are housed in a common cabinet to produce a more efficient source.

14. A loudspeaker system comprising a dynamic driver connected to a driver cone, a VARTL disposed in front of said cone of said dynamic driver, wherein the positioning of at least one wave-guide prevents exit of the frontal wave from any area in front of said cone, wherein the length of said VARTL is extended, and wherein the positioning and the length of said VARTL is extended, and wherein the positioning and the length of said VARTL substantially isolate said dynamic driver from reflective signals.

15. The loudspeaker of claim 14 wherein said VARTL provides damping for the said reflex enclosure thereby replacing internal damping materials normally associated with this function.
